(19) United States
(12) Patent Application Publication
(10) Pub. No.: US 2013/0106586 A1
(43) Pub. Date: May 2, 2013

(54) REMOTE CONTROL

(71) Applicants: MONIQUE S. VIDAL, Brooklyn, NY (US); Joel Vidal, New York, NY (US)

(72) Inventors: MONIQUE S. VIDAL, Brooklyn, NY (US); Joel Vidal, New York, NY (US)

(21) Appl. No.: 13/281,604

(22) Filed: Oct. 26, 2011

(51) Int. Cl. G05B 11/01

(52) U.S. Cl. 340/12.22

(57) ABSTRACT

Disclosed is a remote control unit having a button to selectively disable and enable the physical buttons of the remote control. The remote control unit, which may be able to remotely control an electronic device, may include: a plurality of physical buttons able to receive manual input from a user; and an activator/deactivator physical button able to toggle the remote control unit between a first operational mode and a second operational mode, wherein in the first operational mode the physical buttons are enabled and pressing of the physical buttons affects the operation of the electronic device, and wherein in the second operational mode the physical buttons are disabled and pressing of the physical buttons does not affect the operation of the electronic device.

### FIELD

Some embodiments are related to the field of remote controls.

### BACKGROUND

Electronic devices are part of everyday life. For example, people use televisions to watch news and sporting events, DVD players to watch movies, and Compact Disk (CD) players to playback music.

Some electronic devices include buttons, and the user may be required to be in proximity to the electronic device in order to push the relevant button(s) to operate the electronic device. Some electronic devices are operated by utilizing a wired remote control unit. Some electronic devices are operated by utilizing a wireless remote control unit.

### SUMMARY

Some embodiments may include, for example, a remote control having a button able to enable and disable the remaining buttons of the remote control.

In some embodiments, a remote control unit may be able to remotely control an electronic device; and the remote control unit may include: a plurality of physical buttons able to receive manual input from a user; and an activator/deactivator physical button able to toggle the remote control unit between a first operational mode and a second operational mode, wherein in the first operational mode the physical buttons are enabled and pressing of the physical buttons affects the operation of the electronic device, and wherein in the second operational mode the physical buttons are disabled and pressing of the physical buttons does not affect the operation of the electronic device.

In some embodiments, the remote control unit may further include: an internal power source able to provide power to one or more components of the remote control unit; wherein in the first operational mode, the internal power source provides power to said one or more components of the remote control unit; wherein in the second operational mode, the internal power source does not provide power to said one or more components of the remote control unit.

In some embodiments, the remote control unit may further include: an internal power source able to provide power to one or more components of the remote control unit; wherein in the first operational mode, the internal power source is electrically connected to said one or more components of the remote control unit; wherein in the second operational mode, the internal power source is electrically disconnected from said one or more components of the remote control unit.

In some embodiments, the remote control unit may further include: a wireless transmitter able to transmit wireless communication signals to the electronic device; wherein upon a first pressing of the activator/deactivator physical button, the remote control unit is to transmit to the electronic device a first wireless communication signal commanding the electronic device to ignore subsequent wireless communication signals from the remote control unit until a second, particular, wireless communication signal is sent from the remote control unit commanding the electronic device to be responsive to subsequent wireless communication signals from the remote control unit.

In some embodiments, the remote control unit may further include: an internal power source able to provide power to one or more components of the remote control unit; an illumination unit able to provide backlit illumination; wherein in the first operational mode, the illumination unit is operational and provides backlit illumination in response to pressing of one or more of the physical buttons; wherein in the second operational mode, the illumination unit is non-operational and does not provide backlit illumination in response to pressing of one or more of the physical buttons.

In some embodiments, each one of the physical buttons, upon being pressed down, is to decrease its position by at least two millimeters below a non-pressed position; wherein, when the activator/deactivator physical button indicates the second operational mode, in which the physical buttons are disabled, the electronic device associated with the remote control unit is not operationally responsive to pressing down of one or more of said physical buttons.

In some embodiments, each one of said physical buttons, upon being released subsequent to being pressed down, is to increase its position by at least two millimeters towards a top surface of the remote control unit and to attain said non-pressed position; wherein, when the physical activator/deactivator button indicates the second operational mode, in which the physical buttons are disabled, the electronic device controlled by said remote control is not operationally responsive to releasing of one or more of said physical buttons.

In some embodiments, the activator/deactivator physical button comprises a mechanical switch able to be toggled from being at a first physical state to being at a second physical state; wherein, when the mechanical switch is in the first physical state, the physical buttons are enabled and the electronic device controlled by said remote control unit is enabled; wherein, when the mechanical switch is in the second physical state, the physical buttons are disabled and the electronic device controlled by said remote control unit is enabled.

In some embodiments, the activator/deactivator physical button comprises a mechanical slider able to be slid from being at a first physical position to being at a second physical position; wherein, when the mechanical slider is in the first physical state, the physical buttons are enabled and the electronic device controlled by said remote control unit is enabled; wherein, when the mechanical slider is in the second physical state, the physical buttons are disabled and the electronic device controlled by said remote control unit is enabled.

In some embodiments, the activator/deactivator physical button comprises a physically-pressable button able to be pressed; wherein, in response to being pressed, the physically-pressable button is to decrease its position by at least one millimeter relative to a non-pressed position of said physically-pressable button; wherein, re response to being released subsequent to being pressed, the physically-pressable button is to increase its position and return to said non-pressed position; wherein, in response to being pressed, the physically-pressable button causes a toggle between: (a) the first operational mode, in which the physical buttons are enabled and the electronic device controlled by said remote control unit is responsive to pressing of one or more of the physical buttons, and (b) the second operational mode, in which the physical buttons are disabled and the electronic device controlled by said remote control unit is non-responsive to pressing of one or more of the physical buttons.

In some embodiments, the remote control unit may further include: a wireless transmitter able to transmit wireless communication signals to the electronic device; wherein in the first operational mode, the wireless transmitter is enabled; wherein in the second operational mode, the wireless transmitter is disabled.

In some embodiments, the activator/deactivator physical button comprises a dedicated button that is distinct from a group of physically-pressable keys comprising alpha-numeric characters.

In some embodiments, the physical buttons may be located on a first panel of the remote control unit; and the activator/deactivator physical button may be located on a second panel of the remote control unit; and, for example, the second panel may be generally perpendicular to the first panel.

In some embodiments, the activator/deactivator physical button is a non-child-friendly button.

In some embodiments, the activator/deactivator physical button is to toggle the remote control unit between the first operational mode and the second operational mode while the remote control unit is directed away from the electronic device.

In some embodiments, the activator/deactivator physical button is to toggle the remote control unit between the first operational mode and the second operational mode while the electronic device is temporarily unable to receive wireless communication signals from the remote control unit.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic illustration of a system in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

The term “electronic device” as used herein may include, for example, a television, a monitor, a screen, a plasma television, an LCD screen, a CRT screen, a projector, a LED-based screen, an Organic-LED-based screen, a stereo system, a boom-box device or system, an audio playback system, a video playback system, an audio/video playback system, a DVD player, a DVD recorder, a CD player, a CD recorder, a Blu-ray player, a Blu-ray recorder, an audio recorder device or system, a video recorder device or system, an audio/video recorder device or system, a Video Cassette Player, a Video Cassette Recorder (VCR), a “TiVo” device or box or system, a Digital Video Recorder (DVR) device or system, a set-top box, a dish box, a satellite receiver box, a cable TV box, an Apple TV device, a Google TV device, a D-Link Boxee Box device, a Roku HD/XD/XDS device, a gaming console, a gaming device, a gaming system, a Microsoft Xbox device or system, a Sony PlayStation device or system, a Nintendo GameCube device or system, a Nintendo Wii device or system, a Nintendo DS/3DS device or system, a computer, a desktop computer, a personal computer, a server computer, a laptop, a notebook, a netbook, a tablet computer, a tablet device, a tablet, an ultrabook device or laptop or computer, a portable computing device, a smartphone, a streamer, a streaming device; an air conditioning unit, a heater unit, a cooling unit, a fan; a toaster oven, a broiler, a convection oven, a microwave oven, a conventional oven; a refrigerator, a freezer, a deep-freezer; a kitchen appliance; a living room appliance; a home appliance; an office appliance; a printer; a scanner; an all-in-one device or peripheral; a multiple-purpose device or peripheral; a digital camera able to capture images and/or video; a consumer electronic device; an electric device; a device including one or more processors and/or Integrated Circuits (ICs); a digital device; or the like.

The terms “remote control” or “Remote Control” or “RC” as used herein may include, for example, a remote control unit or device, which may operate using one or more methods, in order to allow a user to remotely control and/or command an electronic device. Such method may include, for example, electromagnetic waves, radio signals, Radio Frequency (RF) signals, InfraRed (IR) signals, IEEE 802.11 wireless communication signals (“Wi-Fi”), Bluetooth, ZigBee, IEEE 802.16 wireless communication signals (“Wi-Max”), Near Field Communication (NFC), Wireless USB, or other suitable methods.

In some embodiments, a remote control may be used in order to control, operate, activate, deactivate, turn-on, turn-off, or otherwise modify the operation of an electronic device, or one or more electronic device. In some embodiments, the remote control may be a remote control able to control one particular device; or, able to control a group of devices (e.g., a television and/or a cable box and/or a DVD player).

In some embodiments, the remote control may be a universal remote control and/or a programmable remote control and/or a general-purpose remote control and/or a multi-purpose remote control, which may be programmed and/or configured and/or adapted and/or taught to control one or more electronic devices which may be of one brand or make or which may be of multiple brands or makes.

In some embodiments, for example, the remote control may include one or more buttons, switches, sliders, keys, keyboard, keypad, numeric keypad, keys corresponding to the digits “0” through “9”, keys corresponding to letters (e.g., “A” to “Z”), one or more volume modification buttons, one or more channel modification buttons, a mute/unmute button able to mute and unmute the audio of the electronic device being controlled, an on/off button able to turn-on and turn-off the electronic device bring controlled, touchpads, track balls, pointing devices, mini-joysticks, or other interface components or input units able to receive manual input (e.g., pushing, releasing, pulling, moving, tilting, accelerating, decelerating, spinning, gesturing) from a user; all of which may be referred to herein as “physical buttons”.

In some embodiments, the remote control may be wired, such that a cable or a wire may connect the remote control to the electronic device being controlled. In other embodiments, the remote control may be wireless, such that the remote control may control the electronic device through wireless communication signals, and without requiring an intermediate cable or a wire or other physical connection between the remote control and the electronic device being controlled.

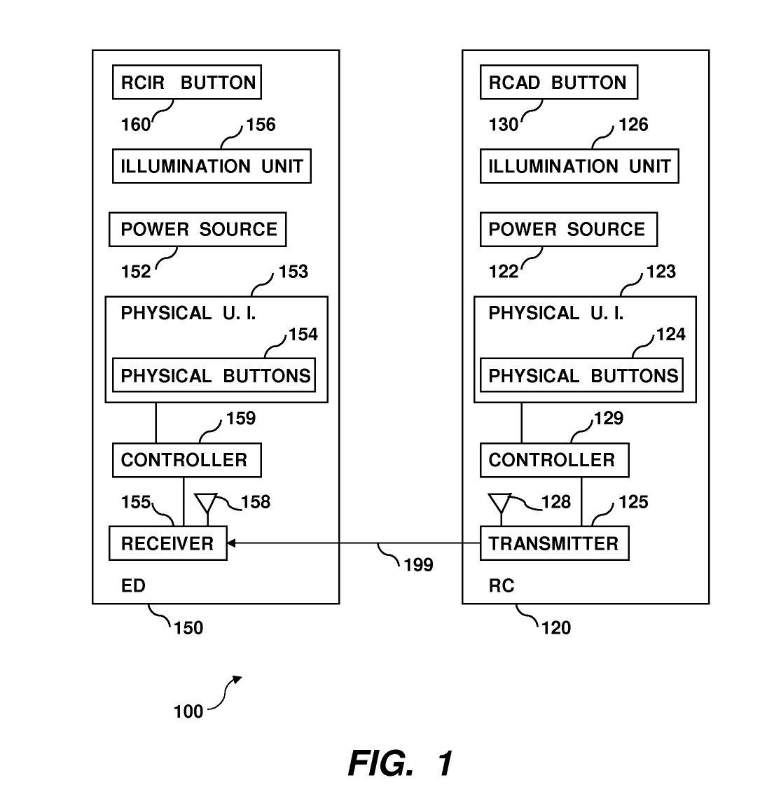

Reference is made to FIG. 1, which is a schematic illustration of a system 100 in accordance with some demonstrative embodiments. System 100 may include a Remote Control (RC) 120 able to control an Electronic Device (ED) 150, for example, over a communication link 199 which may include one or more wireless communication links and/or wired communication links.

RC 120 may include, for example, a housing able to encapsulate and/or hold together the other components of RC 120. The housing may be generally rectangular and/or box-shaped and/or elongated, although other suitable shapes may be used; rounded corners and/or rounded edges may be used.

RC 120 may include an internal power source 122, for example, one or more rechargeable or non-rechargeable batteries or power cells. Power source 122 may provide power, current and/or voltage to one or more other components of RC 120.

RC 120 may include a physical user interface 123 having one or more physical buttons 124. The physical user interface may be able to receive manual input from a user, who may press or release or otherwise handle one or more of the physical buttons 124. Physical user interface 123 may be associated with, or connected or coupled to, a controller 129 able to interpret or convert input received through physical user interface 123 into command(s) that are to be transmitted from RC 120 to ED 150.

In response to receiving such manual input from a user, a transmitter 125 in RC 120 may transmit one or more signals directed at ED 150. In some embodiments, transmitter 125 may be a wireless transmitter, and the transmitted signals may be wireless communication signals. The transmitted signals may correspond to, or may otherwise represent or indicate, commands that the user entered manually on the RC 120. Optionally, transmitter 125 may be associated with an antenna 128.

RC 120 may optionally include an illumination unit 126, which may provide illumination and/or backlit illumination to RC 120 and/or to physical user interface 123 and/or to physical buttons 124 and/or to one or more of the physical buttons 124. The illumination or backlit illumination may allow a user to correctly utilize RC 120 without a need for external or additional illumination, for example, while watching a movie in a dark room.

Optionally, RC 120 may include other suitable components in order to provide to RC 120 additional functionalities or features; for example, a processor, a CPU, a DSP, a small screen, a Seven Segment Display, a memory, a buffer, a small storage unit, or the like.

ED 150 may include, for example, a housing able to encapsulate and/or hold together the other components of ED 150. The housing may be generally rectangular and/or box-shaped and/or elongated, although other suitable shapes may be used; rounded corners and/or rounded edges may be used.

ED 150 may include, or may be coupled to or associated with, an internal and/or external power source 152, for example, one or more rechargeable or non-rechargeable batteries or power cells, a power supply, a power converter, a power transformer, a power socket, an electric socket, a cabled connection to a power outlet or electric outlet providing AC or DC current, or the like. Power source 152 may provide power, current and/or voltage to one or more other components of ED 150.

ED 150 may include a physical user interface 153 having one or more physical buttons 154. The physical user interface may be able to receive manual input from a user, who may press or release or otherwise handle one or more of the physical buttons 154. Physical user interface 153 may be associated with, or connected or coupled to, a controller 159 able to interpret or convert input received through physical user interface 153 into command(s) that ED 150 is to act upon.

In response to receiving such manual input from a user, ED 150 may modify its operation and/or features; for example, ED 150 may commence playback, may pause playback, may resume playback, may stop playback, may stop all operations, may fast-forward, may rewind, may increase or decrease audio volume, may mute or unmute audio, may turn-on the entire ED 150, may turn-off the entire ED 150, may switch ED 150 into a standby mode or a sleep mode or a reduced-power mode, may change a channel, may eject a tray, may initiate a setup process, or the like.

ED 150 may include a receiver 155 able to receive one or more signals transmitted by RC 120. In some embodiments, receiver 155 may be a wireless transmitter, and the received signals may be wireless communication signals. The received signals may correspond to, or may otherwise represent or indicate, commands that a user entered manually on RC 120. Optionally, receiver 125 may be associated with an antenna 158. The received signals may be processed, or acted upon, by controller 159 or other suitable controller or component, for example, processor, CPU, processing core, CPU, or the like.

ED 150 may optionally include an illumination unit 156, which may provide illumination and/or backlit illumination to ED 150 and/or to physical user interface 153 and/or to physical buttons 154 and/or to one or more of the physical buttons 154. The illumination or backlit illumination may allow a user to correctly utilize ED 150 without a need for external or additional illumination, for example, while watching a movie in a dark room.

Optionally, ED 150 may include other suitable components in order to provide to ED 150 additional functionalities or features, and/or in order to perform the main function(s) and/or peripherals function(s) that ED 150 may be capable of. Such components may include, for example, a processor, a CPU, a DSP, a small screen, a Seven Segment Display, a memory, a buffer, a storage unit, a hard-disk drive, a CD drive, a DVD drive, a Solid State Drive (SSD), or the like.

ED 150 may optionally include, for example, audio speakers, audio input jacks or sockets, audio output jacks or sockets, video input jacks or sockets, video output jacks or sockets, audio/video input jacks, audio/video output jacks, HDMI ports, SVGA ports, DV ports, USB ports, FireWire ports, RCA sockets, RGB sockets, Y—Pb—Pr sockets, digital sockets or ports, analog sockets or ports, or the like.

In some embodiments, system 100 may be toggled between two states or modes of operation, or among multiple states or modes of operation. In a first mode, both ED 150 and RC 120 may be fully operational. In a second mode, ED 150 may be fully operational, whereas RC 120 may be non-operational. In a third, optional, mode, ED 150 may be fully operational, whereas RC 120 may be semi-operational or partially-operational.

### First Set of Demonstrative Embodiments

A first set of demonstrative embodiments may include, for example, a remote control unit which includes its own, built-in, integral, on/off button that locally activates/deactivates the operation of the remote control unit itself, separately from the ability of the remote control unit (when in an activated mode) to remotely activate and deactivate (turn-on and turn-off) the remote ED 150.

In some embodiments, for example, RC 120 may include an RC-Activator-Deactivator (RCAD) button 130. The RCAD button 130 may be a physical button or a physical switch, which may be physically or manually pushed or pulled or moved by a user, from a first physical position or location, to a second physical position or location; and vice versa. When RCAD button 130 is at a first position or location, RC 120 may be completely non-operational or turned-off or deactivated; whereas, when RCAD button 130 is at a second position or location, RC 120 may be fully-operational and/or fully activated.

For example, when RCAD button 130 is at the first position or location, power may not flow from power source 122 to substantially any other component of RC 120, thereby disabling or deactivating all the other components of RC 120, and thereby disabling or deactivating all the features and/or functionalities of RC 120 (except for the functionality of the RCAD 130 button itself). Alternatively, when RCAD button 130 is at the first position or location, power may flow from power source 122 to all the other components of RC 120 which require power in order to operate; thereby enabling all the features and/or functionalities of RC 120. For example, deployment or actuation of RCAD button 130, may toggle between opening an closing of one or more electric circuits within RC 120, which provide or transfer power from power source 122 to other component(s) of RC 120.

### Second Set of Demonstrative Embodiments

A second set of demonstrative embodiments may include, for example, a remote control unit having RCAD button 130 able to move or toggle between two positions. In a first position, transmitter 125 of RC 120 may be enabled, and substantially all the other components of RC 120 may be enabled. In the second position, transmitter 125 of RC 120 may be disabled, and substantially all the other components of RC 120 may be disabled. This set of demonstrative embodiments may not cut, and may not break, the flow of power from power source 122 of RC 120 to non-transmitting components of RC 120. Rather, when RCAD button 130 is in the second position, the flow of power only to transmitter 125 may be cut or broken, without interrupting or disrupting the flow of power to other components of RC 120. Alternatively, when RCAD button 130 is in the second position, transmitter 125 may be disabled, but not by cutting or breaking the flow of power to transmitter 125; rather, by configuring transmitter 125 to avoid or to block or to suppress transmittal of communication signals as long as RCAD button 130 is in its second position, and to resume transmittal of communication signals once RCAD button 130 returns to its second position.

### Third Set of Demonstrative Embodiments

A third set of demonstrative embodiments may include, for example, a remote control unit having RCAD button 130 able to move or toggle between two positions. In a first position, transmitter 125 of RC 120 may be enabled, and substantially all the other components of RC 120 may be enabled. In the second position, transmitter 125 of RC 120 may be disabled; one or more other components of RC 120 may be likewise disabled; and one or more other components of RC 120 may be enabled. For example, when RCAD button 130 is in the second position, transmitter 125 may be disabled, e.g., by cutting or breaking the power flow to transmitter 125, or by commanding transmitter 125 to avoid or suppress or block transmissions while RDAC 130 maintains its second position. In parallel, one or more other components of RC 120 may also be disabled, such as by cutting or breaking the flow of power to them, thereby conserving energy and reducing power consumption; such as, by disabling or breaking the flow of power to one or more Integrated Circuits (ICs) of RC 120. However, while RCAD button 130 is in the second position, one or more other (non-transmitter) components of RC 120 may remain operational and/or enabled, such as, for example, illumination unit 125. For example, even though transmitter 125 of RC 120 is disabled or deactivated (and optionally, while one or more other components of RC 120 may be disabled or deactivated), illumination unit 125 of RC 120 may still provide illumination or backlit illumination, for example, continuously and/or upon pressing of one or more of the physical buttons 124.

### Fourth Set of Demonstrative Embodiments

In other embodiments, when RCAD button 130 is at a first position or location, RC 120 may be in a fully-operational mode; whereas, when RCAD button 130 is at a second position or location, one or more components of RC 120 which are necessarily required for the successful transmittal of a command to ED 150, may be disabled or deactivated. For example, instead of or in addition to deactivating the transmitter 125, when RCAD button 130 is in the second position, then one or more ICs or controllers or memory units of RC 120 may be disabled or deactivated, such as, by cutting or breaking the power flow to such component(s).

### Fifth Set of Demonstrative Embodiments

In some embodiments, actuation or RCAD button 130 on the RC 120 may not disable or enable, locally, the operation of other component(s) of RC 120; but rather, actuation of RCAD button 130 on the RC 120 may cause transmitter 125 to transmit a signal to ED 150, the signal indicating to ED 150 to toggle between: (a) a first mode, in which ED 150 receives and processes (acts upon) signals incoming from RC 120; and (b) a second mode, in which ED 150 receives but ignores, or does not process (does not act upon) signals incoming from RC 120. In such embodiments, RC 120 may remain locally functional, and components of RC 120 may continue to consume power from power source 122, and may continue to be activated and enabled; however, ED 150 may be remotely toggled between ignoring and processing the communication signals received from RC 120.

### Sixth Set of Demonstrative Embodiments

In some embodiments, RC 120 may not include RCAD button 130 at all, and RC 120 may be a conventional RC unit; whereas ED 150 may include an RC Ignorer/Responder (RCIR) button 160 which may be toggled between two positions or location. When RCIR button 160 of ED 150 is in the first position or location, ED 150 may receive incoming signals from RC 120, and may process (act upon) such incoming signals incoming from RC 120. In contrast, when RCIR button 160 of ED 150 is in the second position or location, ED 150 may ignore, or may avoid processing, or may avoid acting upon, signals incoming from RC 120; or may avoid receiving signals from RC 120 (e.g., by deactivating or disabling receiver 155 of ED 150, as long as RCIR button 160 is in the second position). Such embodiments may optionally allow, for example, a first user to manually override the operation of RC 120 by a second user. For example, a child may hold RC 120 and may push various physical buttons of RC 120, and may object to giving the RC 120 to an adult user requesting the RC 120. A parent or caregiver may approach the ED 150, and may push or actuate RCIR button 160 from the first position to the second position, thereby commanding ED 150 to ignore any signals incoming from RC 120. Then, the parent or caregiver may utilize the physical user interface 154 of ED 150, in order to perform one or more operations (e.g., resume playback, fast-forward, un-pause, change channel, modify volume level; or, to undo or cure any “damage” or interruption to normal playback that was caused by the handling of RC 120 by the child). The parent or caregiver may thus not be required to gain physical access to the RC 120 (e.g., by physically taking the RC 120 from the child, who may object), in order to stop and/or cure any disruptions to the operation of ED 150 which may have been caused already, or may be caused subsequently, by the child who held or holds the RC 120.

### Seventh Set of Demonstrative Embodiments

In a seventh set of demonstrative embodiments, features of multiple embodiments discussed herein may be combined together. For example, in a demonstrative implementation, RC 120 may include RCAD button 130, and also, ED 150 may include RCIR button 160. In such demonstrative implementation, for example, RCAD button 130 may allow a user to locally activate and/or deactivate the RC 120; and in addition, RCIR button 160 may allow a user (the same user, or another user) to command ED 150 to toggle between ignoring and processing signals that are incoming from RC 120. This demonstrative implementation may allow a user (e.g., a parent or a caregiver) two levels of control over the functionality of the RC 120.

For example, in a demonstrative example, a parent may utilize RC 120 to command a DVD player to start playback of a movie. The parent may then switch the RCAD button 130 to the second position, in order to ensure that the playback of the movie remains uninterrupted even if a child plays with the RC 120 (as long as the child does not push the RCAD button 130 back into the first position). If the parent forgot to push the RCAD button 130 into the second position which disables the RC 120, or, if the child gains possession of the RC 120 and then manages to push the RCAD button 130 back into the first position, then, the parent may have two routes: (a) the parent may gain possession of the RC 120 in order to activate the RC 120 (using the RCAD button 130) and to cure any disruptions or modifications performed by the child; and/or (b) the parent may approach the ED 150, and may toggle the RCIR button 160 into the second position, thereby commanding the ED 150 to ignore or to avoid processing any signals incoming from RC 120 (and optionally, the parent may utilize the physical user interface 154 of ED 150, in order to perform one or more operations to undo or cure any “damage” or interruption to normal playback that was caused by the handling of RC 120 by the child.

Reference is now made again to FIG. 1, to further discuss additional features of system 100. In some embodiments, RC 120 and ED 150 may be manufactured, sold and/or provided as a package or as a kit, or by a single manufacturer or vendor. In other embodiments, RC 120 may be manufactured, sold and/or provided by entities, vendors or manufacturers which may different from those of ED 150, or vice versa. In some embodiments, RC 150 may be provided as a replacement unit or as a third-party alternative to an original RC unit which may be typically provided by a manufacturer of ED 150 to purchasers of ED 150.

In some embodiments, RC 120 may include a physical switch or physical button or physical key, which may be implemented as RCAD 130, and may be able to toggle the physical buttons 124 of RC 120 between an enabled mode and a disabled mode. For example, a first deployment or actuation of RCAD 130 may cause physical buttons 124 of RC 120 to be disabled; a second deployment or actuation of RCAD 130 may cause physical buttons 124 of RC 120 to be enabled; a third deployment or actuation of RCAD 130 may cause physical buttons 124 of RC 120 to be disabled again; and so forth.

Some embodiments may allow a user, for example, to press a button on RC 120, thereby commanding ED 150 to begin playing a movie or a slide-show or a video-clip (e.g., on a DVD player and/or a television); and to then deploy or actuate RCAD 130 in RC 120 (and/or RCIR 160 in ED 150) in order to disable or deactivate physical buttons 124 of RC 120, until RCAD 130 of RC 120 (and/or RCIR 160 of ED 150) is deployed or actuated again to enable or activate physical buttons 124 of RC 120. This may allow the user, as well as other viewers or an audience, to enjoy an uninterrupted presentation of content by ED 150, without a concern that such presentation be accidentally or intentionally interrupted if the user, or if a third party (e.g., a child of the user) accidentally or intentionally hits or pushes or touches one or more of physical buttons 124 of RC 120.

In some embodiments, an optional touchpad or track-ball or joystick or pointing device of RC 120, may remain enabled and operational while physical button s124 of RC 120 are disabled or deactivated by RCAD 130 (and/or by RCIR 160 of ED 150). In some embodiments, ED 150 may remain substantially fully enabled and operational and functional while physical buttons 124 or RC 120 are disabled or deactivated; and ED 150 may continue to operate, for example, by transferring audio/video signals to a television for playing a the movie or other content stored on DVD media.

Some embodiments, for example, may allow a parent or a caregiver to utilize a portable or non-portable DVD player in order to show content (e.g., a video, a movie, an audio clip, an audio/video clip, an image, or the like) to a child or toddler or infant or baby, which may be seated on a parent's lap or next to such presented content; and yet, may eliminate the risk or the concern that such child, accidentally or intentionally, may hit or press or touch one or more physical buttons 124 of RC 120 and may thus cause interruption in the presentation of content (e.g., stopping the presentation, pausing it, aborting it, muting it, changing volume, changing channel, changing source of presentation, or the like).

Some embodiments may thus provide a desired balance, for example, between the need to place a child or infant or toddler or baby in relative proximity to a DVD player and/or a television or other type of ED 150, or in the same room with such devices, so that such child may see and hear the content presented to him or her; with the need to ensure that accidental or intentional moves or gestures, or hand or body movements, of such child, particularly with regard to RC 120, do not interrupt or abort the presentation of content through ED 150.

Some embodiments may allow a parent or caregiver or adult to commence watching television, or to commence watching a movie through a DVD player; and then deploy RCAD 130 in RC 120 (and/or RCIR 160 in ED 150) in order to disable physical buttons 124 (all of them, or some of them) in RC 120. Then, a child may be able to take or grab RC 120, and to play with it and push buttons on it, without interrupting or modifying the playback of broadcast or the movie (or other content), and without actually controlling ED 150 which RC 120 may operate when RC 120 is operational. This may allow the parent or caregiver to enjoy uninterrupted playback of broadcast of the movie or other content, while the child engages with RC 120 (e.g., as a toy or as an object-of-interest that a child desires to explore) in a non-disruptive manner. Once the parent or caregiver desires to once again control the playback of the movie or other content, then the parent or caregiver may take RC 120 (e.g., from the child, or from a nearby table or location where RC 120 may be); and may deploy or actuate or switch RCAD 130 (and/or RCIR 160 of ED 150), thereby switching RC 120 into fully operational mode in which physical buttons 124 of RC 120 are operational and functional and are and responsive to manual actions (e.g., pushing, releasing, sliding, touching, or the like).

Some embodiments may allow a user, for example, to utilize ED 150 which may be an audio/video recorder, in order to begin recording a long program or content (e.g., twenty minutes, one hour, three hours, or the like); then, the user may deploy RCAD 130 in RC 120 (and/or RCIR 160 in ED 150) in order to disable or deactivate physical buttons 124 of RC 120, thereby ensuring that other persons (or the user himself) do not accidentally or intentionally interrupt or terminate such audio/video recording, until RCAD 130 (and/or RCIR 160) is deployed again to enable physical buttons 124 (e.g., once the audio/video program being recorded terminates). Optionally, some embodiments may allow the user to leave his or her audio/video recorder running, and to successfully achieve such long program recording, with reduced concern that third parties tamper with, or interrupt or abort, such program recording, intentionally or accidently; or without a concern that the user himself may accidentally drop RC 120 to the ground and thus may accidentally cause RC 120 to command ED 150 to stop or pause the audio/video recording.

In some embodiments, RCAD 130 of RC 120, and/or RCIR 160 of ED 150, may effectively disable or deactivate the operation of RC 120, while maintaining ED 150 enabled and functional and operating (e.g., playing back a movie or a television presentation, or other audio/video content or presentation). In some embodiments, optionally, the actuation or deployment of RCAD 130 of RC 120, and/or RCIR 160 of ED 150, may also disable or deactivate an optional touch-pad and/or joystick and/or track-ball which may optionally be included in RC 120, together with disabling or deactivating physical buttons 124 of RC 120; and a subsequent actuation or deployment of RCAD 130 of RC 120, and/or RCIR 160 of ED 150, may enable or activate such optional component of RC 120, together with enabling or activating physical buttons 124 of RC 120.

Additionally or alternatively, in some embodiments, optionally, the actuation or deployment of RCAD 130 of RC 120, and/or RCIR 160 of ED 150, may also disable a button (or multiple buttons) of an optional touch-pad component of RC 120, together with disabling physical buttons 124 of RC 120; and a subsequent actuation of RCAD 130 of RC 120, and/or RCIR 160 of ED 150, may enable such previously-disabled button (or multiple buttons) of such optional touch-pad of RC 120.

In some embodiments, optionally, the actuation or deployment of RCAD 130 of RC 120, and/or RCIR 160 of ED 150, may effectively disable or deactivate all input units and/or feedback components and/or manual input components of RC 120 except for RCAD 130, thereby effectively disabling the ability of RC 120 to remotely control ED 150; and a subsequent actuation or deployment of RCAD 130 of RC 120, and/or RCIR 160 of ED 150, may enable or activate such previously-disabled input units and/or feedback components and/or manual input components of RC 120.

In some embodiments, RC 120 and/or ED 150 may include suitable hardware components and/or software components, for example, a physical keyboard (or keypad, or set of keys, or set of buttons), a touchpad, a track-ball, a joystick, a button, a switch, a pointing device; a hard disk drive; a solid-state drive; Flash memory; Random Access Memory (RAM); Read Only Memory (ROM); firmware; volatile memory; non-volatile memory; or other types of storage unit(s) and/or memory unit(s); a Central Processing Unit (CPU), a processor, a Digital Signal Processor (DSP), a Graphics Processing Unit (GPU), an audio processing unit (“sound card” or other audio-processing circuit or chip), a video processing unit (“video card” or other video-processing circuit or chip), a communication bus or communication bridge, a modem, a wireless modem, a wired modem, a wireless or wired transceiver, one or more antennas, a controller, an Integrated Circuit (IC), and/or other suitable components; an Operating System (OS), drivers for various internal components and/or external accessories, and various software applications; internal and/or external power sources and/or illumination sources; electric socket able to receive power from an external power source; and/or other suitable components.

An optional Touchpad may be included in RC 120, and may include, for example a pointing device having a tactile sensor implemented as a touch-sensitive surface which may be capable of translating the motion and/or position of a user's finger(s) to a relative position on a screen, and/or able to translate a user's gesture or movement of finger(s) to suitable operations (e.g., zoom in, zoom out, scroll down or up or sideways, or the like). The touchpad may include, or may be in proximity to, one or more clickable or pressable buttons or bar(s) which may be similar in their operation to the button(s) of a mouse input unit.

RC 120 or physical buttons 124 may include, for example, a physical keyboard or keypad having multiple physical keys, for example, corresponding to alpha-numeric characters of a natural language and to other suitable keys. For example, the physical keyboard may include a set of physical keys corresponding to: the English letters A through Z, the digits 0 through 9, punctuation characters (e.g., period, comma, semicolon), other characters (e.g., space, brackets, slash, backslash, plus sign, minus sign), as well as navigation keys (e.g., cursor keys, page up, page down, home, end) and control keys and modifier keys (e.g., ALT key, SHIFT key, CTRL key, Windows key, function keys F1 through F12, an Enter or Return key).

In some embodiments, the physical keyboard of RC 120 may include at least one pair of two physical keys which may be identical to each other or may perform identical function(s) (e.g., a pair of SHIFT keys, a pair of CTRL keys, a pair of ALT keys, or the like). In some embodiments, the physical keyboard may include one or more physical keys which correspond to Channel Up, Channel Down, Volume Up, Volume Down, Mute, Play, Pause, Stop, Fast Forward, Fast Backward, Next Chapter, Previous Chapter, On, Off, and the like. Optionally, the physical keyboard may include a physical numeric keypad having the digits 0 through 9.

In some embodiments, each one of physical buttons 124 may be physically pressable or pushable, and may change its height or location or size (e.g., by at least 1 millimeter or by at least 2 millimeters or by at least 3 millimeter, or other suitable value) upon application of pressure by a user's finger on such physical button 124. For example, each physical button 124 may include a square or rectangular surface or panel, located on top of a mechanical lever or electronic switch or spring or membrane. Each such surface or panel may have, over it, one or more symbols (e.g., the digit 4 and the dollar character $), which may be printed or engraved or etched on such surface or panel, or may be glued thereon.

In some embodiments, physical buttons 124 may be manufactured or provided as one-piece monoblock unit, positioned over one or more contact-switch membrane sheets having a space layer between. When physical pressure is applied to a particular physical key 124 pressing it downward, a top membrane may move downward in that particular location and may touch a bottom membrane or a lower membrane; the particular location may correspond to a particular electrical contact being made, thereby indicating a particular character or symbol received as user input, or corresponding to a particular command or signal that RC 120 is intended to transmit to ED 150.

Physical buttons 124 may include (or may be connected to, or may be associated with, or may be coupled to) keyboard-related or key-related circuitry which may be able to convert physical presses (and/or releases and/or other gestures) of one or more physical buttons 124 into key codes or other signals that RC 120 may interpret and understand, and may convert into signals or commands which may then be transmitted to ED 150 for ED 150 to act upon or respond to. For example, in physical buttons 124, key switches may be connected via a printed circuit board in an electrical X-Y matrix, and a voltage may be provided sequentially to the Y lines; once a key is pressed down, the voltage may be detected sequentially by scanning the X lines. Physical buttons keys 124 may be associated with or connected to power source 122 of RC 120.

RCAD 130 of RC 120, and/or RCIR 160 of ED 150, may be or may include a switch or button able to toggle between (a) activation or enablement of physical buttons 124, and (b) deactivation or disabling of physical buttons 124, and vice versa. RCAD 130 of RC 120, and/or RCIR 160 of ED 150, may be, for example, a physical or mechanical or electro-mechanical toggle switch which may be physically or mechanically toggled by a user (manually) from a first position or location to a second position or location, and vice versa; for example, by pushing or pulling or moving a mechanical protrusion or lever or stick or pin, within or along a channel or crater or recess. Alternatively, RCAD 130 of RC 120, and/or RCIR 160 of ED 150, may be, for example, a slider or a sliding switch able to slide mechanically from a first position to a second position, and vice versa. Alternatively, RCAD 130 of RC 120, and/or RCIR 160 of ED 150, may be a turn-able knob or radio-button, which may be turned clockwise or anti-clockwise between or among two or more angular positions. Alternatively, RCAD 130 of RC 120, and/or RCIR 160 of ED 150, may be a button which may be pressed down and then may remain being pressed down, until a further pressing releases the button and makes it assume (or spring back to) its previous non-pressed position. Alternatively, RCAD 130 of RC 120, and/or RCIR 160 of ED 150, may be a button similar in its physical properties to a power button of a laptop computer, such that, for example, a first press may deactivate physical buttons 124 while the button assumes its original non-pressed position; whereas a subsequent press may activate physical buttons 124 while the button assumes its original non-pressed position, and so forth.

RCAD 130 of RC 120 may be located at a suitable location in RC 120, for example: on a side panel, on a right-side panel, on a left-side panel, on a top-side panel, on a bottom-side panel, near one or more physical buttons 124, in an area of RC 120 which may be relatively distant from (or secluded from, or separate from, or distinct from) physical buttons 124, on a panel which may be substantially perpendicular to the panel in which physical buttons 124 are located, in a section or area of RC 120 which may be near a battery chamber or a battery slot or a battery cover, or the like.

RCIR 160 of ED 150 may be located at a suitable location in ED 150, for example: on a side panel, on a right-side panel, on a left-side panel, on a top-side panel, on a bottom-side panel, near one or more physical buttons 154, in an area of ED 150 which may be relatively distant from (or secluded from, or separate from, or distinct from) physical buttons 154, on a panel which may be substantially perpendicular to the panel in which physical buttons 154 are located, in a section or area of ED 150 which may be near a battery chamber or a battery slot or a battery cover, or the like.

In some embodiments, RCAD 130 of RC 120 and/or RCIR 160 of ED 150 may be implemented as a switch or button which may be difficult to a user to push or pull or move or deploy; or, as a switch or button which may be difficult to an adult user to push or pull or move or deploy; or, as a switch or button which may be difficult to a minor user or a child user to push or pull or move or deploy; as a switch or button which may be virtually impossible for a user to push or pull or move or deploy without utilizing a tool (e.g., by utilizing a pin or a pen or a pencil to push-in or to move a small button or an internal button); or, as a switch or button which may require a user to utilize a fingernail to push or pull or move or deploy; or, as a switch or button which may be non-child-friendly, or may be child-proof, or may be child-hostile or a button that a child may not be able to actuate or move or switch (e.g., at all, or without help of an adult or a tool), or may be difficult for a child to move or actuate, or may be hidden from plan view of a child, or may be significantly smaller (e.g., at least 50 percent smaller) than the average size of the other buttons of RC 120; or the like.

Upon deployment of RCAD 130 of RC 120 and/or RCIR 160 of ED 150, toggling may occur between activating and deactivating physical buttons 124 of RC 120 100; or, toggling or switching may occur among three or more modes, two of such modes may be a physical buttons 124 enabled mode and a physical buttons 124 disabled mode). Such toggling or switching may occur without interrupting or affecting other functionality of ED 150, and without causing ED 150 to go into standby mode or sleep mode or hibernation mode or reduced-power mode, and without causing ED 150 to turn-off itself completely or partially.

In some embodiments, when RCAD 130 of RC 120 is in a “physical buttons 124 enabled” position or mode, then, RCAD 130 of RC 120 may physically connect as a component within an electric circuit which provides power to physical buttons 124 and/or to transmitter 125 of RC 120. Whereas, when RCAD 130 of RC 120 is in a “physical buttons 124 disabled” position or mode, then, RACD 130 of RC 120 may physically disconnect or break an electric circuit which provides power to physical buttons 124 and/or to transmitter 125 of RC 120.

In some embodiments, when RCIR 160 of ED 150 is in a “RC 120 enabled” position or mode, then, RCIR 160 may physically connect as a component within an electric circuit which provides power to receiver 165 of ED 150. Whereas, when RCIR 160 of ED 150 is in a “RC 120 disabled” position or mode, then, RCIR 160 of ED 150 may physically disconnect or break an electric circuit which provides power to receiver 165 of ED 150.

In some embodiments, when RCAD 130 is in a “RC 120 enabled” position or mode, then, RCAD 130 may physically connect as a component within an electric circuit which provides power to a keyboard controller (e.g., a hardware-based keyboard controller) which controls physical buttons 124 or some of them. Whereas, when RCAD 130 is in a “RC 120 disabled” position or mode, then, RCAD 130 may physically disconnect or break an electric circuit which provides power to a keyboard controller (e.g., a hardware-based keyboard controller) which controls physical buttons 124 or some of them.

In some embodiments, when RCAD 130 is in a “RC 120 enabled” position or mode, then, RCAD 130 may physically or electrically enable transfer of signals and/or data, over a wired connection or link or circuit, in the direction going from physical buttons 124 towards the keyboard controller (e.g., a hardware-based keyboard controller) which controls physical buttons 124; or from such keyboard controller towards other components of RC 120 (e.g., transmitter 125). Whereas, when RCAD 130 is in a “RC 120 disabled” position or mode, then, RCAD 130 may physically or electrically disable or stop or break or block transfer of signals and/or data, over a wired connection or link or circuit, in the direction going from physical buttons 124 towards the keyboard controller (e.g., a hardware-based keyboard controller) which controls physical buttons 124; or from such keyboard controller towards other components of RC 120 (e.g., transmitter 125). Similar operating principles may apply to RCIR 160 of ED 150.

In some embodiments, when RCAD 130 is in a “RC 120 disabled” position or mode, then, RCAD 130 may disable or turn-off or suspend or deactivate or break an electric circuit or a communication circuit of, for example, one or more software component and/or hardware components, of physical buttons 124 and/or of RC 120; which are associated, for example, with the proper operation of physical buttons 124, and/or with transfer of signals or data from physical buttons 124 to other component(s) of RC 120, and/or with providing power or voltage or current to physical buttons 124 or to other components associated with physical buttons 124. Whereas, when RCAD 130 is in a “RC 120 enabled” position or mode, then, RCAD 130 may enable or turn-on or activate or complete or connect an electric circuit or a communication circuit of, for example, one or more software component and/or hardware components, of physical buttons 124 and/or of RC 120; which are associated, for example, with the proper operation of physical buttons 124, and/or with transfer of signals or data from physical buttons 124 to other component(s) of RC 120, and/or with providing power or voltage or current to physical buttons 124 or to other components associated with physical buttons 124. Similar operating principles may apply to RCIR 160 of ED 150.

In some embodiments, RCAD 130 may be implemented as multiple physical or mechanical switches which may have a logical OR relation among them (e.g., such that deactivation of one of such switches may suffice in order to deactivate or disable physical buttons 124); or as multiple physical or mechanical switches which may have a logical AND relation among them (e.g., such that deactivation of all of such switches may be required in order to deactivate or disable physical buttons 124); or as multiple physical or mechanical switches which may have other types of logical relation among them (e.g., such that each one of the multiple switches may activate and deactivate physical buttons 124 upon toggling of such switch, independently of the position or mode of the other switch(es). Similar operating principles may apply to RCIR 160 of ED 150.

In some embodiments, optionally, RCAD 130 may be implemented as a unified physical switch which may be able to activate or deactivate, both physical buttons 124 and an optional touchpad of RC 120, at the same time or substantially at the same time. For example, deployment of RCAD 130 may concurrently enable, or may concurrently disable, both physical buttons 124 and such optional touchpad; or may otherwise concurrently toggle among activation and deactivation of these two input units of RC 120. For example, when RCAD 130 is in a position or mode of “physical buttons 124 and touchpad disabled”, then, RCAD 130 may deactivate or disable one or more software and/or hardware components (e.g., controllers, drivers, or the like), or may break or disconnect one or more electric circuits or communication links, which may be associated with the proper operation of physical buttons 124 and the touchpad, or may break or disconnect one or more links or circuits which transfer data or signals from physical buttons 124 and/or from the touchpad to a controller or processor or transmitter 125 of RC 120. Whereas, when RCAD 130 is in a position or mode of “physical buttons 124 and touchpad enabled”, then, RCAD 130 may activate or enable one or more software and/or hardware components (e.g., controllers, drivers, or the like), or may connect one or more electric circuits or communication links, which may be associated with the proper operation of physical buttons 124 and the touchpad, or may break or disconnect one or more links or circuits which transfer data or signals from physical buttons 124 and/or from the touchpad to a controller or processor or transmitter 125 of RC 120. Optionally, RCAD 130 may similarly control, toggle, deactivate and/or activate a set of input units together, for example, physical buttons 124, an optional touchpad in RC 120, an optional track-ball in RC 120, or the like.

In some embodiments, deployment or actuation of RCAD 130 into a position or mode of “physical buttons 124 disabled”, may operate to block or eliminate, for example: (a) substantially all signals or data or commands going from physical buttons 124 to a keyboard controller or a communication bus associated with physical keyboard 103, or to transmitter 125; and/or (b) substantially all signals or data or commands going from physical buttons 124 to other components associated with physical buttons 124; and/or (c) substantially all signals or data or commands going from physical buttons 124 to an OS or software or firmware of RC 120; and/or (d) substantially all signals or data or commands going from physical buttons 124 to a keyboard driver of RC 120; and/or (e) the providing or the flow, of power or current or voltage, to (or from) physical buttons 124; and/or (f) the providing or the flow, of power or current or voltage, to (or from) a hardware-based keyboard controller associated with physical buttons 124; and/or (g) other components or links or connections which may be required for full and proper operation of physical buttons 124. Whereas, deployment or actuation of RCAD 130 into a position or mode of “physical buttons 124 enabled” may perform contrarian operation(s) to achieve the opposite result(s), in which signals or data or commands from physical buttons 124 properly reach the OS or CPU or controller or transmitter 125 of RC 120 and/or are properly processed (or acted upon) by RC 120 or by transmitter 125 (and subsequently, by ED 150).

In some embodiments, deployment or actuation of RCAD 130 into a position or mode of “physical buttons 124 disabled”, may be translated into (or interpreted as) a command directed to the OS or the CPU or keyboard driver or keyboard controller of RC 120 (and/or of ED 150), commanding one or more of these components to ignore (or not store, or not process, or not act upon, or discard) substantially all signals or data or commands incoming from physical buttons 124; until a contrarian command (e.g., to stop ignoring) is transferred, e.g., via RCAD 130 upon its deployment or actuation into a position or mode of “physical buttons 124 enabled”.

In some embodiments, RCAD 130 and/or RCIR 160 may be operational to toggle between disabling and enabling physical buttons 124 as a stand-alone mechanical switch or button, or in a single-step process, or in a process which does not require any user-initiated modifications of settings in a “control panel” or in “settings” or “definitions” interface in RC 120 and/or in ED 150; and may not require the user to use a mouse, or touchpad, or physical buttons 124 themselves, in order to enable and/or disable physical buttons 124; and may not require the user to navigate through one or more menus or options or windows, or to open windows or to open applications, or to select or unselect boxes or options or check-boxes or radio-buttons or drop-down menus or other interface elements, to achieve such purposes of toggling between enabled and disabled modes of physical buttons 124.

In some embodiments, RCAD 130 may be operational to autonomously and/or independently (e.g., independently of ED 150) toggle between disabling and enabling physical buttons 124 without the need to direct RC 120 towards ED 150, and/or while RC 120 is not directed towards ED 150, and/or while RC 120 is directed away from ED 150, and/or while RC 120 is not within the reception range or reception field-of-view of ED 150, and/or while RC 120 is located in another geo-spatial location (e.g., in another room, or in another office, or in another house) than ED 150, and/or while ED 150 is unable to receive wireless signals from RC 120 (e.g., due to long distance between ED 150 and RC 120; due to interference; due to blockage or blocking items, such as walls or obstacles; due to RC 120 having a weak battery as internal power source; due to RC 120 having a “dead” battery or substantially empty or depleted battery as internal power source), and/or while ED 150 is temporarily unable to receive wireless communication signals from RC 120, and/or without having to utilize RC 120 to remotely control ED 150 (e.g., by navigating through one or more menus) for the purpose of disabling/enabling physical buttons 124 of RC 120.

Some embodiments may thus provide a one-click or one-movement or one-pull or one-push or one-gesture operation, to substantially immediately toggle between enablement and disablement of physical buttons 124 of RC 120; or to toggle between ignoring of, and acting upon, signals that that RC 120 transmits to ED 150.

In some embodiments, optionally, the operation or functionality of RCAD 130 (and/or RCIR 160) may be part of a multi-step process, which may, for example, further require the user to enter a pre-defined password or Personal Identification Number (PIN) in order to allow such toggling to take effect. For example, physical deployment of RCAD 130 (and/or RCIR 160), from a keys-enabled mode to a keys-disabled mode, and/or vice versa, may require the user to enter a pre-defined or user-defined password or PIN. In some embodiments, such deployment of RCAD 130 and/or of RCIR 160, may trigger a process in which RC 120 and/or ED 150 ask the user to select a password, which then RC 120 and/or ED 150 may store, and that the user may later be required to enter upon attempting to toggle back from a keys-disabled mode to a keys-enabled mode. In some embodiments, the password required to confirm or authorize the toggling may be an OS password, a boot-process password, a BIOS password, a user log-in password, an Administrator password, a dedicated password used uniquely or distinctly in conjunction with the toggling of physical buttons 124, or other type of user-defined or user-modifiable password.

In some embodiments, RCAD 130 (and/or RCIR 160) may auto-deploy itself (e.g., particularly if RCAD 130 and/or RCIR 160 are implemented as a mechanically-pressable button which may be similar in its mechanical properties to a power button of a laptop computer); for example, if RC 120 and/or ED 150 detect (e.g., autonomously and without having to receive particular or additional user indication) that one or more pre-defined and/or user-modifiable conditions hold true. For example, RCAD 130 (and/or RCIR 160) may be implemented as a physical button which may be similar to a power button of a conventional laptop computer, such that the physical button may be physically pressed down approximately 1 or 2 or 3 millimeters, and when released it may rise back to its non-pressed position. Such RCAD 130 (and/or RCIR 160) may self-deploy or self-actuate (e.g., may function as if it was pressed and released, without actually decreasing and increasing in height), for example, may automatically and autonomously and independently toggle from a buttons-enabled mode to a buttons-disabled mode, if one or more of the following conditions hold true: (a) ED 150 is utilized to view or open or play or launch a presentation (e.g., PowerPoint presentation or PPT file or PPS file), a video file (e.g., AVI file, DIVX file, MP4 file, MOV file, QuickTime file, WMV file, FLV file), an audio file (e.g., MP3 file, Ogg Vorbis file, WMA file, WAV file), a streaming video (e.g., on YouTube, on Amazon), a streaming audio (e.g., on YouTube, on Amazon), a DVD disk, a Compact Disk, or other multimedia presentation or audio/video clip or file or segment; (b) a pre-defined or user-defined or user-modifiable time-period (e.g., 20 seconds or one minute) elapsed since physical buttons 124 were last used or pressed; (c) both of the above conditions (a) and (b) cumulatively hold true; (d) the user (via ED 150) is viewing an item or an application or a file or an audio/video clip by using Full Screen View, such as, by instructing ED 150 to show or display or present content by utilizing the entire screen and while hiding menu(s) and/or buttons and/or a seek bar and/or other user-interface components; (e) other suitable conditions, or a combination of multiple conditions, hold true. In some embodiments, ED 150 and/or RC 120 may include hardware logic and/or circuitry and/or software (e.g., driver, or OS component, or an application) able to automatically monitor and autonomously sense or detect whether the pre-defined condition(s) hold true (e.g., able to monitor and detect that the user or RC 120 or ED 150 initiated playback of a video, a presentation, a DVD or a CD); and may thus automatically initiate the toggling from the buttons-enabled mode to the buttons-disabled mode. In some embodiments, toggling-back from buttons-disabled mode to buttons-enabled mode may be allowed and/or performed only by the user pressing (or otherwise deploying or actuating) RCAD 130 (and/or RCIR 160), and not by operating or utilizing physical buttons 124 which has been automatically disabled.

RCAD 130 may be connected and/or operative at one or more suitable locations along the route in which data, signals and/or commands flow from one or more physical buttons 124 and onward. For example, RCAD 130 may be connected, or may be operative, between membranes which lie underneath or within physical buttons 124; between such membranes and a voltage or current provider to such membranes; between such membranes and a voltage scanner or a matrix scanner or a row scanner which captures key-presses; between such scanner and a keyboard controller, or keyboard control circuitry, or keyboard interpretation circuitry, which is operative to capture key-presses and translate them into signals or commands or data corresponding to (or indicating) the pressed physical key(s); between such keyboard control circuitry (or keyboard interpretation circuitry) and a communication bus or communication link of RC 120 which collects or receives or transfers signals or data received from one or more input units; between such keyboard control circuitry (or keyboard interpretation circuitry) or a communication bus or communication link, and a processor or CPU or other controller of RC 120 which is generally operative to receive signals, data and/or commands that originate in key-press(es) and to act upon them, or to process them, or to store them, or to command other components of RC 120 to act upon them, or to transfer them to other components of RC 120 (e.g., to transmitter 125); between a processor or CPU or controller of RC 120, and a storage unit or memory unit or buffer utilized for storing data corresponding to incoming key-presses; between physical buttons 124 and transmitter 125; or at other suitable location(s) within RC 120.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device (e.g., a device incorporating functionalities of multiple types of devices, for example, PDA functionality and cellular phone functionality), a vehicular device, a non-vehicular device, a mobile or portable device, a non-mobile or non-portable device, a wireless communication station, a wireless communication device, a wireless Access Point (AP), a wireless Base Station (BS), a Mobile Subscriber Station (MSS), a wired or wireless Network Interface Card (NIC), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.16m standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or tag or transponder, a device which utilizes Near-Field Communication (NFC), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a “smart-phone” device, an iPhone or a similar device, an iPod or iPod Touch or iPad or iPad-2 or Motorola Xoom or similar device, a wired or wireless handheld device (e.g., BlackBerry Curve or Torch, or HTC Incredible, or Samsung Galaxy Tab), a handheld or portable e-reader or electronic reader or electronic book reader (e.g., Amazon Kindle, or Amazon Kindle Fire, or Barnes & Noble Nook), a hybrid e-book reader and tablet device, a device running Apple iOS operating system, a device running Android operating system, a Wireless Application Protocol (WAP) device, a hybrid device (e.g., combining one or more cellular phone functionalities with one or more PDA device functionalities), a portable audio player, a portable video player, a portable audio/video player, a portable media player, a gaming device, a portable or non-portable gaming console, a portable device having a touch-screen, a relatively small computing device, a non-desktop computer or computing device, a portable device, a handheld device, a “Carry Small Live Large” (CSLL) device, an Ultra Mobile Device (UMD), an Ultra Mobile PC (UMPC), a Mobile Internet Device (MID), a Consumer Electronic (CE) device, an “Origami” device or computing device, a device that supports Dynamically Composable Computing (DCC), a context-aware device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), OFDM Access (OFDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth®, Global Positioning System (GPS), IEEE 802.11 (“Wi-Fi”), IEEE 802.16 (“Wi-Max”), ZigBee™, Ultra-Wideband (UWB), Global System for Mobile communication (GSM), 2G, 2.5G, 3G, Third Generation Partnership Project (3GPP), 3GPP Long Term Evolution (LTE), 3.5G, or the like. Some embodiments may be used in conjunction with various other devices, systems and/or networks.

The terms “wireless device”, “wireless computing device”, “mobile device” or “mobile computing device” as used herein include, for example, a portable or mobile device capable of wireless communication, a portable or mobile communication device capable of wireless communication, a mobile phone, a cellular phone, a laptop or notebook computer capable of wireless communication, a PDA capable of wireless communication, a handheld device capable of wireless communication, or the like.

The terms “web” or “Web” as used herein includes, for example, the World Wide Web; a global communication system of interlinked and/or hypertext documents, files, web-sites and/or web-pages accessible through the Internet or through a global or regional or national communication network; including text, images, videos, multimedia components, hyperlinks, and/or other content which may be available online.

The term “user” as used herein includes, for example, a person or entity that owns a laptop computer; a person or entity that operates or utilizes a laptop computer; or a person or entity that is otherwise associated with a laptop computer.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” or “a plurality” as used herein include, for example, “multiple” or “two or more”. For example, “a plurality of items” includes two or more items.

Some embodiments may take the form of an entirely hardware embodiment, an entirely software embodiment, or an embodiment including both hardware and software elements. Some embodiments may be implemented by utilizing firmware, resident software, microcode, or the like.

Some embodiments may take the form of (or may utilize) a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (e.g., keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, JavaScript, BASIC, Pascal, Fortran, Cobol, assembly language, machine code, machine language, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

What is claimed is:

1. A remote control unit able to remotely control an electronic device,
the remote control unit comprising:
a plurality of physical buttons able to receive manual input from a user; and
an activator/deactivator physical button able to toggle the remote control unit between a first operational mode and a second operational mode, wherein in the first operational mode the physical buttons are enabled and pressing of the physical buttons affects the operation of the electronic device, and wherein in the second operational mode the physical buttons are disabled and pressing of the physical buttons does not affect the operation of the electronic device.

2. The remote control unit of claim 1, further comprising:
an internal power source able to provide power to one or more components of the remote control unit;
wherein in the first operational mode, the internal power source provides power to said one or more components of the remote control unit;
wherein in the second operational mode, the internal power source does not provide power to said one or more components of the remote control unit.

3. The remote control unit of claim 1, further comprising:
an internal power source able to provide power to one or more components of the remote control unit;
wherein in the first operational mode, the internal power source is electrically connected to said one or more components of the remote control unit;
wherein in the second operational mode, the internal power source is electrically disconnected from said one or more components of the remote control unit.

4. The remote control unit of claim 1, further comprising:
a wireless transmitter able to transmit wireless communication signals to the electronic device;
wherein upon a first pressing of the activator/deactivator physical button, the remote control unit is to transmit to the electronic device a first wireless communication signal commanding the electronic device to ignore subsequent wireless communication signals from the remote control unit until a second, particular, wireless communication signal is sent from the remote control unit commanding the electronic device to be responsive to subsequent wireless communication signals from the remote control unit.

5. The remote control unit of claim 1, further comprising:
an internal power source able to provide power to one or more components of the remote control unit;
an illumination unit able to provide backlit illumination;
wherein in the first operational mode, the illumination unit is operational and provides backlit illumination in response to pressing of one or more of the physical buttons;
wherein in the second operational mode, the illumination unit is non-operational and does not provide backlit illumination in response to pressing of one or more of the physical buttons.

6. The remote control unit of claim 1, wherein each one of the physical buttons, upon being pressed down, is to decrease its position by at least two millimeters below a non-pressed position;
wherein, when the activator/deactivator physical button indicates the second operational mode, in which the physical buttons are disabled, the electronic device associated with the remote control unit is not operationally responsive to pressing down of one or more of said physical buttons.

7. The remote control unit of claim 5, wherein each one of said physical buttons, upon being released subsequent to being pressed down, is to increase its position by at least two millimeters towards a top surface of the remote control unit and to attain said non-pressed position;
wherein, when the physical activator/deactivator button indicates the second operational mode, in which the physical buttons are disabled, the electronic device controlled by said remote control is not operationally responsive to releasing of one or more of said physical buttons.

8. The remote control unit of claim 1, wherein the activator/deactivator physical button comprises a mechanical switch able to be toggled from being at a first physical state to being at a second physical state;
wherein, when the mechanical switch is in the first physical state, the physical buttons are enabled and the electronic device controlled by said remote control unit is enabled;
wherein, when the mechanical switch is in the second physical state, the physical buttons are disabled and the electronic device controlled by said remote control unit is enabled.

9. The remote control unit of claim 1, wherein the activator/deactivator physical button comprises a mechanical slider able to be slid from being at a first physical position to being at a second physical position;
wherein, when the mechanical slider is in the first physical state, the physical buttons are enabled and the electronic device controlled by said remote control unit is enabled;
wherein, when the mechanical slider is in the second physical state, the physical buttons are disabled and the electronic device controlled by said remote control unit is enabled.

10. The remote control unit of claim 1, wherein the activator/deactivator physical button comprises a physically-pressable button able to be pressed;
wherein, in response to being pressed, the physically-pressable button is to decrease its position by at least one millimeter relative to a non-pressed position of said physically-pressable button;
wherein, re response to being released subsequent to being pressed, the physically-pressable button is to increase its position and return to said non-pressed position;
wherein, in response to being pressed, the physically-pressable button causes a toggle between: (a) the first operational mode, in which the physical buttons are enabled and the electronic device controlled by said remote control unit is responsive to pressing of one or more of the physical buttons, and (b) the second operational mode, in which the physical buttons are disabled and the electronic device controlled by said remote control unit is non-responsive to pressing of one or more of the physical buttons.

11. The remote control unit of claim 1, further comprising:
a wireless transmitter able to transmit wireless communication signals to the electronic device;
wherein in the first operational mode, the wireless transmitter is enabled;
wherein in the second operational mode, the wireless transmitter is disabled.

12. The remote control unit of claim 1, wherein the activator/deactivator physical button comprises a dedicated button that is distinct from a group of physically-pressable keys comprising alpha-numeric characters.

13. The remote control unit of claim 1, wherein the physical buttons are located on a first panel of the remote control unit; wherein the activator/deactivator physical button is located on a second panel of the remote control unit; wherein the second panel is generally perpendicular to the first panel.

14. The remote control unit of claim 1, wherein the activator/deactivator physical button is a non-child-friendly button.

15. The remote control unit of claim 1, wherein the activator/deactivator physical button is to toggle the remote control unit between the first operational mode and the second operational mode while the remote control unit is directed away from the electronic device.

16. The remote control unit of claim 1, wherein the activator/deactivator physical button is to toggle the remote control unit between the first operational mode and the second operational mode while the electronic device is temporarily unable to receive wireless communication signals from the remote control unit.
